(19) United States
(12) Patent Application Publication
(10) Pub. No.: US 2017/0064033 A1
(43) Pub. Date: Mar. 2, 2017

(54) SYSTEMS AND METHODS FOR A SOCIAL NETWORKING PLATFORM

(71) Applicant: Speakbeat Mobile Application, Inc., Santa Monica, CA (US)

(72) Inventors: Dean Stackel, Santa Monica, CA (US); Scott Snell, Beverly Hills, CA (US); Bernard Lee, Los Angeles, CA (US); Neama Dadkhahnikoo, Los Angeles, CA (US); Xiaolu Sang, Playa Vista, CA (US)

(73) Assignee: Speakbeat Mobile Application, Inc., Santa Monica, CA (US)

(21) Appl. No.: 14/833,544

(22) Filed: Aug. 24, 2015

(51) Int. Cl. H04L 29/08; H04L 12/58

(52) U.S. Cl. CPC H04L 67/306; H04L 51/32

(57) ABSTRACT

Systems and methods for hosting and/or interacting with a social network use a set of postings. Individual postings include a question and may include a set of selectable answers to the question. Users provide their response to the question in a posting. Users can see the answers of other users in their social network and others that are on the platform to the same question. Users can provide predictions for particular users in their social network or for others on the platform, and vice versa.

### FIELD OF THE INVENTION

The systems and methods described herein generally relate to hosting and interacting within a social networking platform, and, in particular, various embodiments relate to systems and methods to allow users to provide answers and/or predictions of answers to questions associated with postings on the social networking platform and/or to track the downstream behavior of users after the initial user has interacted with content.

### BACKGROUND OF THE INVENTION

The advent of online social networking has provided a convenient way for people to stay connected and informed about news, events, and other topics, even across great distances. Since its inception, social media has increased widely in use and popularity and has stimulated a great deal of interaction among users who otherwise may have had a difficult time staying in touch. In addition to sharing photographs and stories and other current events in their lives, users are fond of sharing opinions as well. Indeed, many people are especially interested in the opinions of friends and other people they know as well as the opinions of celebrities, athletes, and/or influencers.

### SUMMARY

Embodiments of the systems and methods described herein relate to interactive, online social networking systems that can be used to allow users to share their opinions about various current events or other topics of interest to them, and to predict how their friends or social media contacts will opine on these same topics. As with other social networking systems, users will be allowed to form networks of friends, create postings for friends, and reply to various postings. In further embodiments, postings can include questions posed to the users of the social networking platform on various topics. The questions can take the form of, for example, multiple-choice questions, yes/no questions, questions requiring a written response, and so on. The questions can ask for responses in the form of opinion, fact, or other response, and the user is given the opportunity to answer these questions. In some embodiments, the user can also be given the opportunity to predict how other users (e.g., his or her friends on the social network platform, or celebrities, athletes, and/or influencers) will answer questions posted on the platform. The system can further be figured to share these predictions with other users, tell the user how successful he or she has been at predicting the answers of friends, and provide other statistics and information to the users about their friends' answers and their own skills at predicting how their friends will respond.

Accordingly, one aspect of the disclosed technology relates to a system for hosting a social networking platform that enables users to interact with other users and, through communication, form social networks. Each user may create and maintain a personal social network of friends and other contacts that are connected to that user through the system. Social networks of different users may overlap, or they may be formed as discrete networks. Users may publish, post, and/or otherwise make available information to other users, in particular the users in their social network. Such information may be referred to as postings. For example, editors, journalists, and/or users may create content for posting. The created content can take many forms and in some instances can be in the form of questions that users of the social network system can provide answers to. Accordingly, the users may answer, react, reply, and/or otherwise respond to these postings, which can include answering questions provided by the poster. Users may subscribe or follow particular content creators (and/or their channels) and receive their postings, as well is a postings of others. The system may be deployed, at least in part, using a public network such as the Internet and/or using commercial web services.

The system may include one or more of electronic storage, physical processors, computer program components, and/or other components. The system may include a server that communicates with, by way of non-limiting example, one or more client computing platforms that are associated with one or more users, one or more communication networks, and/or other entities described herein. Individual users may interact, e.g. through browser software applications being executed on client computing platforms, with one or more servers. Individual users may interact, e.g. through browser software applications being executed on client computing platforms, with other users. By way of non-limiting example, the one or more communication networks may include the internet, and/or other communication networks. As used herein, mobile applications such as apps are included in the term browser software application. The browser software application may be configured to render, interpret, and/or display information for presentation on a computing platform.

Client computing platforms may include one or more processors configured to execute computer program components. The computer program components may be configured to enable a user associated with a client computing platform to interact with the system, any component thereof, other client computing platforms, and/or provide other functionality attributed herein to client computing platforms. By way of non-limiting example, client computing platforms may include one or more of a desktop computer, a laptop computer, a handheld computer, a NetBook, a mobile telephone, a “smart phone”, a tablet, a mobile computing platform, a gaming console, a television, an electronic device, and/or other computing platforms. Users may communicate using any of the computing platforms described in this disclosure, and/or any combination of computing platforms described in this disclosure.

The server may include one or more processors configured to execute computer program components. The computer program components may include an account management component, a feed posting component, a posting selection component, a user interface component, a posting presentation component, an aggregation component, a prediction component, a notification component, a gamification component, a score component, a virality component, and/or other components.

The account management component may be configured to manage user accounts associated with users. Individual user accounts may include information that identifies a set of users that form the social network of the individual user.

The feed posting component may be configured to obtain postings. As used herein, the term “obtain” (and derivatives thereof) may include active and/or passive retrieval, determination, derivation, transfer, upload, download, submission, and/or exchange of information, and/or any combination thereof. In some embodiments, individual postings may include one or more postings of various content such as, for example, postings on events or other topics, or questions to be answered. In some embodiments, such as for multiple-choice questions or yes/no questions, individual postings may include two or more selectable answers to the question. “Radio buttons” or other selection mechanisms can be provided in the user interface to allow the user to select the desired answer. Postings may be obtained, for example, from editors, journalists, celebrities, athletes, influencers, and/or other users. In some embodiments, individual postings may include a selectable link to one or more online articles, videos, animations, gifs or sound recordings related to the question. In some embodiments, a posting may be in the format of text, video, animations, gifs, sound recordings, and/or other formats.

The posting selection component may be configured to effectuate the posting of information, questions, or other presentations to users. As used herein, the term “effectuate” (and derivatives thereof) may include active and/or passive causation of any effect. For example, effectuating a presentation may include presenting information to a user (for example through an electronic display on a client computing platform associated with the user) and/or causing such a presentation of information, e.g. through electronically stored and/or streamed computer-readable instructions, commands, and/or other mechanisms. Effectuation may include local causation (e.g. on a client computing platform and/or server), remote causation (e.g. over a network), and/or any combination thereof. Presented information may include one or more representations that represent postings. The posting selection component may be configured to select which postings to present to a particular user. Selection by the posting selection component may be user-specific. The postings selection component may be configured to select in which order to present postings to a particular user. Ordering by the posting selection component may be user-specific. By way of non-limiting example, a representation of a posting may include one or more images, videos, animations, gifs, sound, text, one or more hyperlinks, user interface elements, and/or other information. In some embodiments, a representation of a particular posting may include some or all of the information of the particular posting. In some embodiments, a representation of a particular posting may include a portion of the particular posting and/or a link to the particular posting.

The user interface component may be configured to provide information to and receive user input from users. For example, the user interface component may be configured to receive user input through the user interface of a client computing platform. In some embodiments, the received user input may select one or more representations and/or postings. In some embodiments, the received user input may select one or more user interface elements that are included in a representation and/or posting. For example, user input may include entry, selection, and/or confirmation of an option offered in a graphical user interface. For example, user input may include tapping, clicking, swiping, and/or otherwise gesturing on a touchscreen display and/or in proximity of a sensor. For example, user input may include entering text, comments, links to pictures, articles, and/or other content, and/or other information. In some embodiments, user input may include content creation, including but not limited to creation and/or publication of new postings, modifications of existing postings, new answers to existing postings/questions, modifications of existing answers, and/or other types of content creation by a user within the social networking platform.

The user interface component may also be configured to receive user input from users that provides one or more answers to one or more questions. For example, the user input may provide a particular answer to a particular question of a particular posting.

The posting presentation component may be configured to effectuate presentations to users. Presentations may include representations and/or postings. In some embodiments, the posting presentation component may be configured to effectuate a particular presentation of a particular posting to a user. For example, the particular posting may be represented by a particular representation that has been selected through user input. Postings may include questions. A particular posting may include a particular question. In some embodiments, a particular posting may include a particular set of answers to the particular question.

The aggregation component may be configured to obtain and/or determine aggregates of answers to one or more questions. For example, the aggregation component may be configured to determine a particular aggregate of the answers provided by a set of users to a particular question. For example, a particular question may have two selectable answers, “yes” and “no.” An aggregate of the answers provided by a set of users may be “65% yes”, “35% no”, and/or both. The posting presentation component may be configured to effectuate presentations to users that include and/or are based on one or more answers provided by users and/or an aggregate. As used herein, the term “determine” (and derivatives thereof) may include measure, calculate, compute, estimate, approximate, generate, and/or otherwise derive, and/or any combination thereof.

The prediction component may be configured to receive user input that represents predictions for answers that have been, will be, and/or might be provided by other users to particular questions. For example, the prediction component may be configured to receive a selection of one or more users and subsequently receive a selection of one or more answers to a particular question. A user may provide his or her prediction for the answers that have been, will be, and/or might be provided by other users. For example, a user may provide predictions for other users in his or her social network, celebrities, athletes, and/or influencers, and/or other users that are unrelated to the user.

In some embodiments, the prediction component may be configured to receive predictions for a particular user. For example, this component may be configured to receive the predictions and aggregate the information on these predictions in various ways. It may be configured to gather the information so that it can show to a user how his or her friends predicted he or she would answer various questions. As another example, it may be configured to gather the information on how a user predicted a plurality of his or her friends voted. As a more specific example, ten users in the social network of a first user may predict the particular user's answer to a particular question. An aggregate of the predicted answers provided by the ten users may be “7 yes” and “3 no”. In some embodiments, the particular predicted answers and/or an aggregate thereof may be presented to the first user.

The notification component may be configured to notify and/or effectuate notification to users. In some embodiments, a notification may pertain to an occurrence of a prediction as described in relation to the prediction component. For example, a first user may predict that a second user has provided or will provide an answer to a particular question. The notification component may be configured to notify the second user that the first user has made a prediction pertaining to the second user. If the second user has already answered the question, then the notification may include whether the first user predicted correctly or not. If the second user has not answered the question, then the second user may have the option of answering the question and then seeing if the prediction by the first user was correct (in addition to predicting for the first user, if the second user has not done so already). If the second user had not answered the question and then subsequently does answer the question, then the system may notify the first user of whether their prior prediction for the second user was correct or not. Notifications can take numerous forms, including without limitation, push notification, email notifications, notifications through the app, and/or other types of notifications.

The gamification component may be configured to effectuate the calculation of and/or presentations to users that reflect prediction accuracy of the predictions of users. Prediction accuracy may be calculated in a number of different ways: For example, per other user, for all users, for specific topics (e.g. a user predicts for other users in the Sports category correctly 70% of the time or the user predicts how all users of the platform will answer a particular question or category correctly “X”% of the time). In some embodiments, the gamification component may be configured to present, to a particular user, subsequent to the particular user providing a set of predictions, information that reflects how accurate the predictions by the particular user have turned out to be. In some embodiments, an indication of accuracy level may be specific to a particular user. For example, a first user may predict the answers provided by a second user to a number of questions with 80% accuracy, and may predict the answers provided by a third user to the same or different questions with 50% accuracy. For example, the second user may have predicted the first user's answers with 70% accuracy, whereas the third user may have predicted the first user's answers with 85% accuracy. For every user, the system can calculate and present what questions were predicted correctly and the percentage of questions predicted correctly for any other particular user either in the aggregate or broken down by categories (e.g. a first user accurately predicts for a second user in the Sports category 81% of the time but only predicts accurately in the Politics category 42% of the time). In some embodiments, an indication of accuracy level may be specific to a set of users.

The score component may be configured to determine a quantification for how many users have responded to one or more questions as prompted by (and/or potentially prompted by) the particular posting, question, answer, and/or predictions by a particular user. Alternatively, and/or simultaneously, the score component may be configured to determine a quantification for how many users have provided predictions for the answers to one or more questions as prompted by (and/or potentially prompted by) the particular posting, question, answer, and/or predictions by a particular user. In other words, a particular posting, question, answer, and/or prediction by a particular user may cause activity in a social network, and that activity may in turn cause more activity. The score component may be configured to quantify this activity. In some embodiments, a quantification may include a number of points, credit, and/or countable unit or worth or merit, all of which may be jointly referred to herein as “points”. In some embodiments, one or more of such quantifications for a particular user may be referred to as a virality quotient and/or used as a basis to determine a virality quotient. For example, all or most activity by a user on the social network may correspond to a quantification. In some embodiments, a user's quantifications may be combined, e.g. by addition and/or other arithmetic. In some embodiments, a user's quantifications may be static and/or cumulative, and/or otherwise monotonously increasing. In some embodiments, a user's quantifications may expire, decay, and/or otherwise reduce over time.

The virality component may be configured to effectuate presentations to users that reflect quantifications as determined by, e.g., the score component. In some embodiments, a presentation by the virality component may be an aggregate score for a user and/or may be broken down by question or by category (e.g. Sports or LOL). For example, a particular user's overall virality quotient may be presented over time, and may, for example, reflect an increasing or decreasing level of influence (or at least effect in terms of causing activity) on the social networking platform. For a particular posting, question, answer, and/or other activity, a virality score may provide a sum of all of the downstream activity resulting from the initial activity. In some embodiments, the sum may be calculated in a similar manner for different types of activities (e.g. a prediction may receive the same quantification or point total as asking a question, which may have the same quantification or point total as answering a question). In some embodiments, the system may allocate differing quantifications depending on the type of activity. Moreover, many users may receive quantifications downstream for the same user. By way of example, if a first user answers question number one and a second user also answers question number one, and both users are followed by a third user, then question number one shall appear in the third user's feed (e.g. set of postings) due to the first user answering the question and the second user answering the question and therefore if the third user answers the question, then both the first user and the second user could receive credit and/or points (or any quantifications) for the downstream activity of the third user as well as all downstream activity from the third user. Alternatively, the system may be configured to award credit and/or points (or any quantifications) to just one of the two users (for example, the user that answered the question first).

As used herein, any association (or relation, or reflection, or indication, or correspondency) involving users, user accounts, postings, questions, answers, representations, selections, predictions, notifications, accuracy levels, quantifications, points, credits, activity levels, virality quotients, client computing platforms, and/or another entity or object that interacts with any part of the system and/or plays a part in the operation of the system, may be a one-to-one association, a one-to-many association, a many-to-one association, and/or a many-to-many association or N-to-M association (note that N and M may be different numbers greater than 1).

One aspect of the disclosed technology relates to a system for interacting within a social networking platform that enables a user to interact with other users. In some embodiments, by way of non-limiting example, users may interact through client computing platforms.

One aspect of the disclosed technology relates to methods for hosting a social networking platform and/or interacting within a social networking platform. These methods may enable users to interact with other users.

These and other objects, features, and characteristics of the present disclosure, as well as the methods of operation and functions of the related components of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the any limits. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured to host a social network that enables users to interact with other users, in accordance with one or more embodiments.

FIG. 2-3 illustrate exemplary graphical user interfaces depicting the functionality of a system configured for interaction between users of a social network, in accordance with one or more embodiments.

FIGS. 4-5 illustrate methods for hosting a social network and/or interacting with a social network that enables users to interact with other users, in accordance with one or more embodiments.

FIGS. 6-13 illustrate exemplary graphical user interfaces depicting the functionality of a system configured for interaction between users of a social network, in accordance with one or more embodiments.

### DETAILED DESCRIPTION

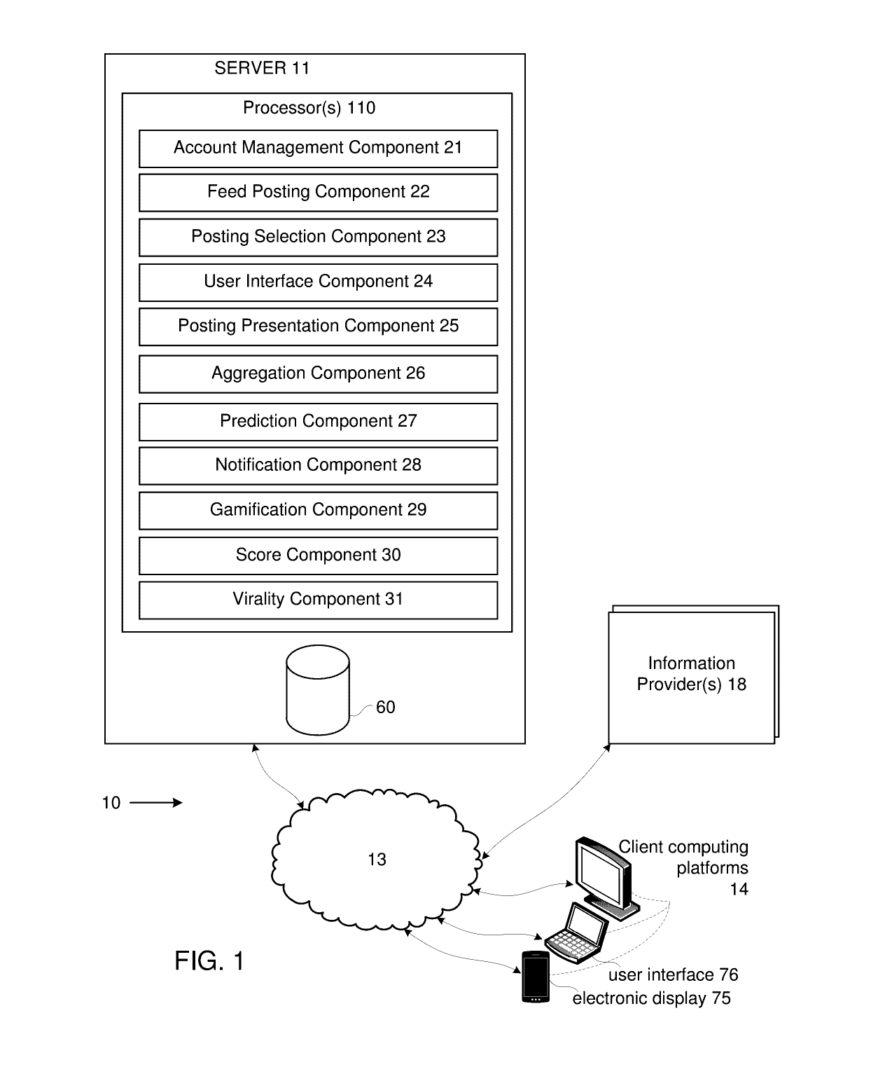

FIG. 1 illustrates an example system 10 that is configured to host a social networking platform that enables users to interact with other users. By way of non-limiting example, interaction between users may include polling and sharing opinions about any type of content, such as current events. In some embodiments, a user's action may be ordered such that a particular question needs to be answered prior to the user making predictions regarding the same question. As illustrated in FIG. 1 by way of non-limiting example, system 10 may include one or more servers 11, one or more client computing platforms 14, one or more information providers 18, electronic storage 60, one or more physical processors 110, one or more computer program components, and/or other components. The components in FIG. 1 may be communicatively coupled through one or more networks 13, including but not limited to the Internet. System 10 may be deployed, at least in part, using network 13 (e.g., a public network), and/or using commercial web services. Server 11 may include one or more physical processors 110, electronic storage 60, a user interface 76, an electronic display 75, and/or other components.

One or more physical processors 110 may be configured to execute computer program components. The computer program components may include an account management component 21, a feed posting component 22, a posting selection component 23, a user interface component 24, a posting presentation component 25, an aggregation component 26, a prediction component 27, a notification component 28, a gamification component 29, a score component 30, a virality component 31, and/or other components.

One or more physical processors 110 may be configured to provide information processing capabilities in system 10 and/or server 11. As such, physical processor 110 may include one or more of a digital processor, an analog processor, a digital circuit designed to process information, an analog circuit designed to process information, a state machine, and/or other mechanisms for electronically processing information. Although physical processor 110 may be shown in FIG. 1 as a single entity, this is for illustrative purposes only. In some embodiments, physical processor 110 may include a plurality of processing units. These processing units may be physically located within the same device, or physical processor 110 may represent processing functionality of a plurality of devices operating in coordination (e.g., “in the cloud”, and/or other virtualized processing solutions).

Account management component 21 may be configured to manage user accounts associated with users. Individual user accounts may include information that identifies a set of users that form the social network of the individual user. In some embodiments, account management component 21 may be configured to manage and/or control access to user accounts, e.g. through an authorization process.

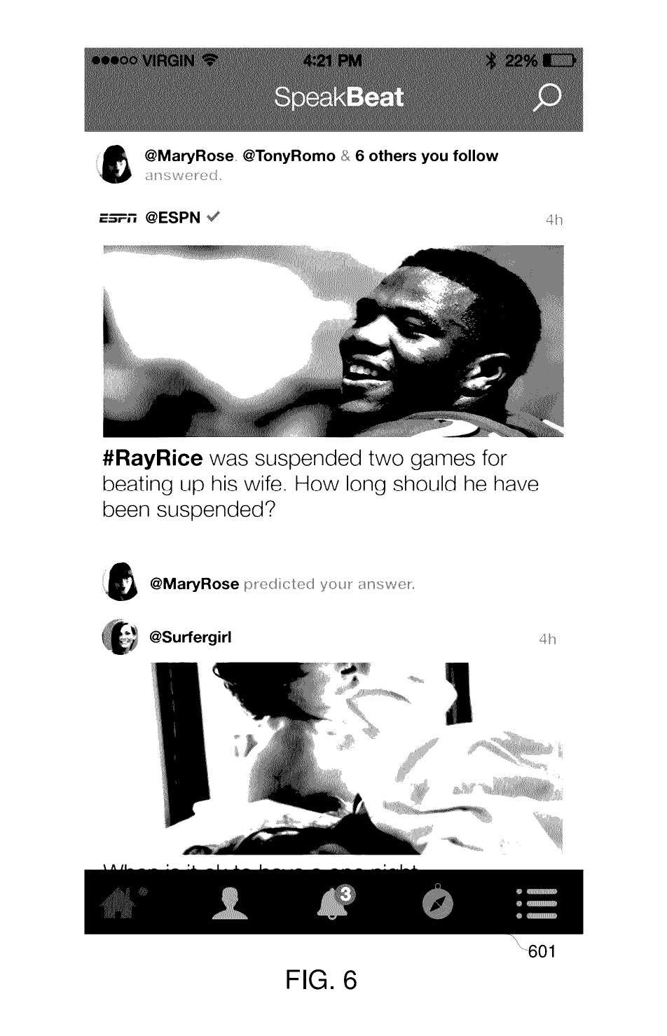

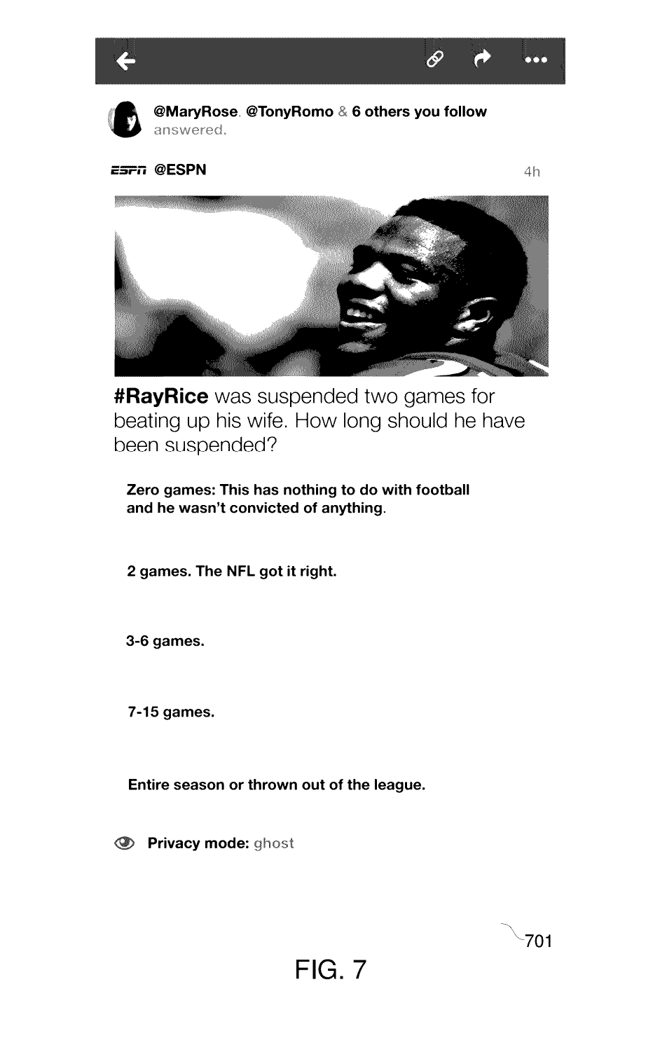

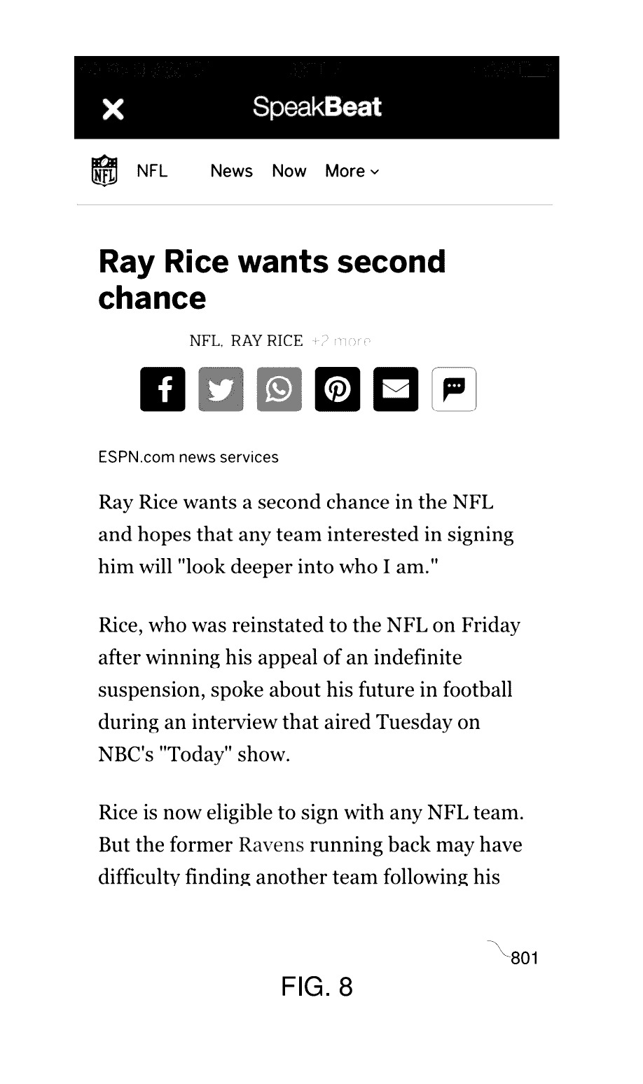

Feed posting component 22 may be configured to obtain postings. In some embodiments, feed posting component 22 may be configured to receive postings from one or more information providers 18. For example, a particular information provider 18 may be associated with a news agency, one or more editors, content creators, users, and/or other content providers. In some embodiments, feed posting component 22 may be configured to receive postings from users of the social network. Individual postings may include a question. Questions may be designed to provoke opinions from users. For example, a view 601 in FIG. 6 illustrates a graphical user interface as may be presented to a user, the view including representations (in this case images) of two postings. The first posting in view 601 includes a question about the suspension of a professional football player for beating up his wife. The second posting in view 601 includes the question “When is it ok to have a one-night stand?”. In some embodiments, individual postings may include one or more selectable answers to the question. In some embodiments, the one or more selectable answers may be presented to a user in a separate view, tab, page, and/or other user interface element in a graphical user interface. For example, a view 701 in FIG. 7 illustrates a graphical user interface as may be presented to a user, the view including multiple selectable answers related to the same question as shown in FIG. 6. The answers may be designed to provoke opinions from users and can be in different forms, including but not limited to text, images, video, gif, emoji's, and/or other forms, as well as combinations thereof. In some embodiments, individual postings may include a selectable link to one or more online articles pertaining to the question. For example, a view 801 in FIG. 8 illustrates a graphical user interface as may be presented to a user, the view including one or more online articles related to the same question as shown in FIG. 6 and FIG. 7.

Posting selection component 23 may be configured to effectuate presentations to users. For example, effectuating a presentation may include presenting information to a user (for example through electronic display 75 on client computing platform 14 associated with the user) and/or causing such a presentation of information, e.g. through electronically stored and/or streamed computer-readable instructions, commands, and/or other mechanisms. Effectuation may include local causation (e.g. on client computing platform 14 and/or server 11), remote causation (e.g. over network 13), and/or any combination thereof. Presentations may include one or more representations that represent postings. By way of non-limiting example, a representation of a posting may include images, text, animations, one or more hyperlinks, and/or other information, as well as combinations thereof. In some embodiments, a representation of a particular posting may include some or all of the information of the particular posting. In some embodiments, a representation of a particular posting may include a portion of and/or a link to the particular posting.

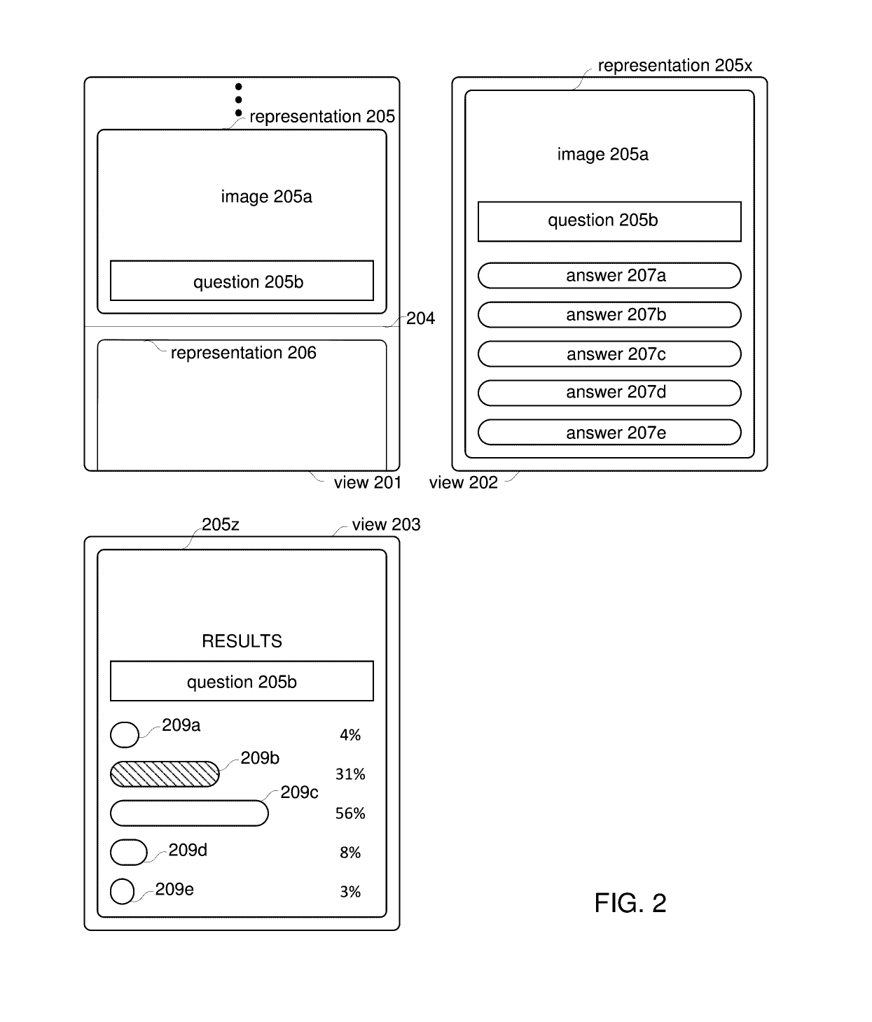

In some embodiments, posting selection component 23 may be configured to present multiple representations to a user on a single user interface. By way of non-limiting example, FIG. 2 illustrates three views of a graphical user interface as may be presented to a user: view 201, view 202, and view 203. View 201 depicts a representation 205 of a particular posting. Representation 205 may include an image 205a and a question 205b. View 201 furthermore depicts another representation 206 of another posting. By way of example, and not limitation, representations 205 and 206 are separated by separator 204, e.g. a line. Representations 205 and 206 may be part of a larger set of representations that a user may reach by scrolling through the depicted representations. By way of non-limiting example, view 601 in FIG. 6 may include similar elements as view 201 in FIG. 2.

In some embodiments, a representation may include a user interface element referred to as “Get the User Interested Area” (also called “GUIA” or informational area) where the system presents information that tempts, induces, entices, and/or otherwise attracts a particular user to engage with a particular posting. For example, the information presented in this area may inform the particular user about reasons that this question is (more) interesting to the particular user and one in which they can engage beyond merely reading the question. The system may inform the particular user of other users that have predicted for the particular user. The system may inform the particular user of any of the people who the particular user follows that have answered the question. In some embodiments, the system may inform the particular user about celebrities, athletes, and/or influencers that have answered the question. In some embodiments, the particular celebrities, athletes, and/or influencers included in the GUIA may be user-specific and/or selected by areas of interest. For example, the system may determine for a particular user what the most interesting information for a particular question is. By way of example, if it is a Sports question and basketball player James Harden has answered the question, the system may include James Harden in the GUIA. If it is not a Sports question, the system may not include him, but rather another celebrity whose appeal is more pertinent to the topic of the question, or to the user-specific interests. In some embodiments, an opinion by a celebrity, athlete, and/or influencer may be added prior to or without them joining the social networking platform, e.g. because their views on this particular question are publicly available through other means (e.g. through interviews). In some embodiments, an opinion by a celebrity, athlete, and/or influencer may be added by someone else than the celebrity, athlete, and/or influencer.

In some embodiments, posting selection component 23 may be configured to present a single representation and/or posting to a user. For example, other representations or postings may be reachable by scrolling up or down (e.g. by using a swiping gesture in the user interface) depicting a single (representation of a) posting. In some embodiments, a particular user-interface gesture may effectuate an animation of a particular representation being moved off-screen (which may include rotating), as if the representation were a playing card being discarded. In some embodiments the user interface will allow the user to move off-screen the representation in either direction, as if the playing card that was discarded is returned so the user can see prior representations that they may have viewed previously. User interface component 24 may be configured to receive user input from users. For example, user interface component 24 may be configured to receive user input through user interface 76 of client computing platform 14. In some embodiments, the received user input may select one or more representations and/or postings. For example, user input may include entry, selection, and/or confirmation of an option offered in a graphical user interface. For example, user input may include tapping, clicking, swiping, throwing, and/or otherwise gesturing on a touchscreen display, with a mouse, and/or in proximity of a sensor.

In some embodiments, the system may be configured to support that users provide modifications and/or commentary on existing postings. In some embodiments, the system may be configured to support that users provide their own answers to existing postings to add to an existing posting, and/or to create a new posting.

Posting presentation component 25 may be configured to effectuate presentations to users. Presentations may include representations and/or postings. Presentations may include graphical user interface elements. Users may be able to interact with graphical user interface elements, e.g. lists, menus, buttons, informational areas, etc., e.g. by selecting and/or activating an element. In some embodiments, posting presentation component 25 may be configured to effectuate a particular presentation of a particular posting to a user. For example, the particular posting may be represented by a particular representation that has been selected through user input. Postings may include questions. In some embodiments, postings may include summaries of a particular issue or topic. A particular posting may include a particular question and/or summary. In some embodiments, a particular posting may include a particular set of answers to the particular question. By way of non-limiting example, FIG. 2 illustrates view 202 depicting a representation 205x of a particular posting as may be presented to a user, subsequent to the user selecting representation 205 in view 201. Representation 205x may include image 205a and question/summary 205b, similar to view 201. View 202 may further include selectable answers 207a-207e. By way of non-limiting example, view 701 in FIG. 7 may include similar elements as view 202 in FIG. 2. The depicted number of answers is exemplary and not intended to be limiting in any way. The depicted shape of the answers is exemplary and not intended to be limiting in any way. For example, the answers may be in any form and/or any functionality, including but not limited to text.

User interface component 24 may be configured to receive user input from users that provides one or more answers to one or more questions. For example, the user input may provide a particular answer to a particular question of a particular posting. By way of non-limiting example, once view 202 has been presented to a user, the user may selects one or more answers 207a-207e. For example, the user may select answer 207b. In some embodiments, user interface component 24 may be configured to provide a public and/or private option for answering a question. A private answer may be referred to as a ghost answer. For example, user interface component 24 may be configured to receive a private answer and/or a public answer to the same question. The public answer may be displayed, e.g. when another user sees the results of a particular question. The private answer may be counted, e.g. to determine the aggregate results of a set of users. Private answers may be kept secure and never displayed except to the user who provided that answer. The system may be configured to track and/or report on these results. For example, 12% of people who publicly state they will vote for one particular political candidate would actually vote for another political candidate, as may be indicated by their private answers.

Aggregation component 26 may be configured to obtain and/or determine results of answers to one or more questions. In some embodiments, results may be aggregated. For example, aggregation component 26 may be configured to determine a particular aggregate of the answers provided by a set of users to a particular question. For example, a particular question may have two selectable answers, “yes” and “no.” An aggregate of the answers provided by a set of users may for example be “65% yes”, “35% no”, and/or both. Posting presentation component 25 may be configured to effectuate presentations to users that include and/or are based on one or more answers provided by users and/or an aggregate. In some embodiments, a result may include an average value. For example, if the answers range on a scale from 1-5, a particular set of users may on average answer 3.7. For example, the cuteness of a video may be rated in this way. In some embodiments, the system may sort and/or rank similar videos by numerical value. The particular set of users may be targeted through demographics. For example, teenagers may rate/answer a video (or other posting) on average by a different score than 3.7. More specifically, teenage boys may rate/answer a video by a specific score. In some embodiments, users can search and/or filter postings and/or other content based on average and/or numerical values, for different sets of users.

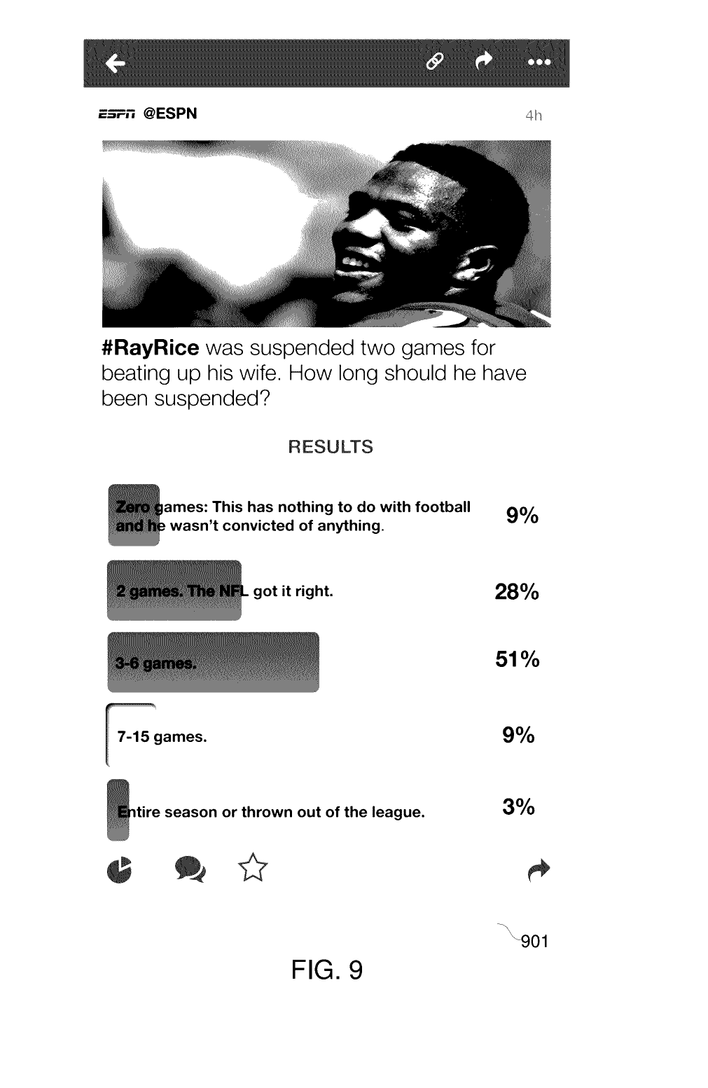

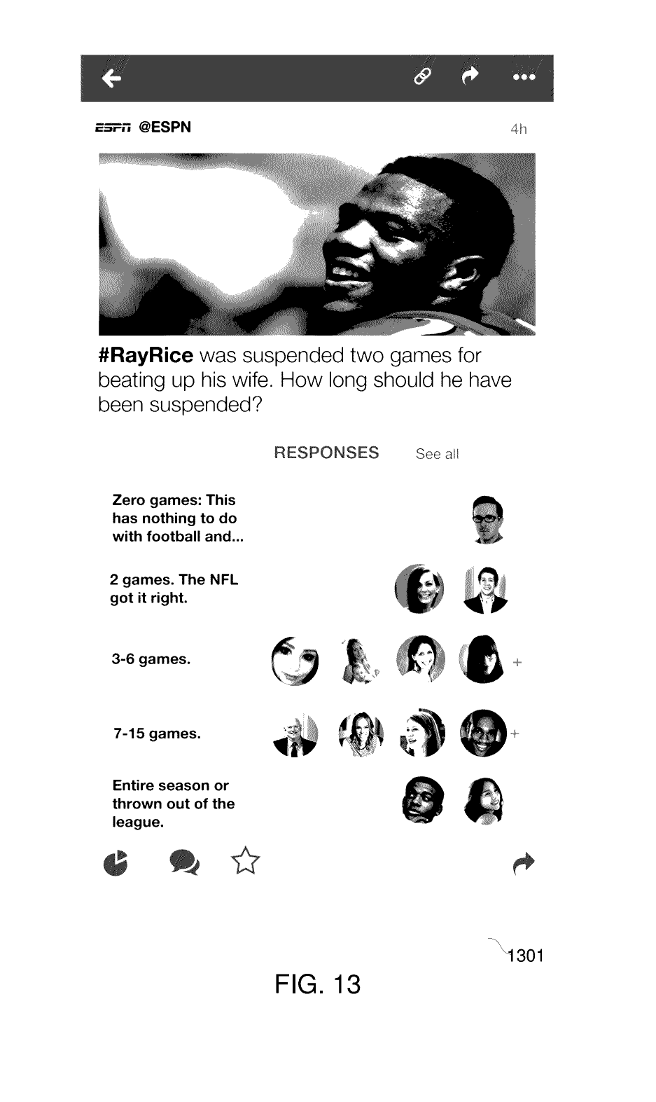

By way of non-limiting example, FIG. 2 illustrates view 203 depicting a representation 205z of a particular posting as may be presented to a user, subsequent to the user selecting representation 205 in view 201 and answering the question in view 202. Representation 205z may include question/summary 205b, similar to view 201. View 203 may further include aggregate information about the answers other users have provided for this particular question. As depicted, view 203 includes aggregate answers and/or results 209a-209e. For example, 4% of users who answered this question answered 207a, 31% answered 207b, 56% answered 207c, 8% answered 207d, and 3% answered 207e, for a total of 100% of, e.g., all the provided answers. The results for 209b may be displayed in a distinct manner from the other results to indicate that the user selected the corresponding answer 207b. By way of non-limiting example, view 901 in FIG. 9 may include similar elements as view 203 in FIG. 2. By way of non-limiting example, view 1301 in FIG. 13 may include similar elements as view 203 in FIG. 2, as well as specific results from users in a particular social network.

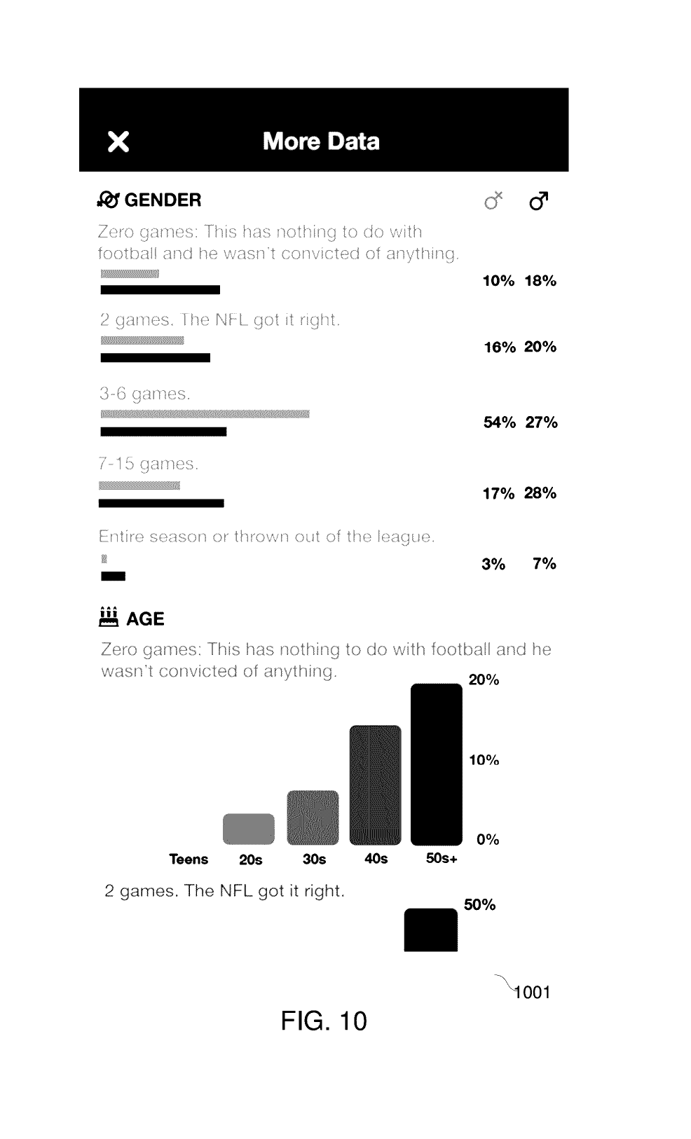

In some embodiments, results may be presented based on demographic information. For example, the percentage of men or women who have selected a particular answer may be depicted. User-specific demographic information may include age, gender, race, economic status, geographic information, sexual preference, sexual orientation, political preference, and/or other demographic information, and/or combinations thereof. By way of non-limiting example, view 1001 in FIG. 10 may present similar results as view 901 in FIG. 9 and/or view 203 in FIG. 2, further specified and/or based on demographic information, such as, e.g., gender and age. In some embodiments, the system may provide options for a user to “slice and dice” the results and/or predictions. For example, a teenage boy may want to know what other teenage boys think about a certain movie. For example, a network or an advertiser might want to know what black women between ages 30 and 40 think about something or target them with content and/or ads.

In some embodiments, results may be presented based on demographic-specific quotas. Individual demographic categories may be represented by selected and/or pre-selected users. For example, a particular demographic category may have (at least) a predetermined number of users included in it, such that the combined results for the particular demographic category may be statistically significant. Larger communities of users (e.g. for a university) may use demographic categories to weigh results accordingly. For example, if 9% of the student population of a particular university is gay, the opinions of the students in the particular demographic category representing gay students may account for 9% of the opinion of the entire student population.

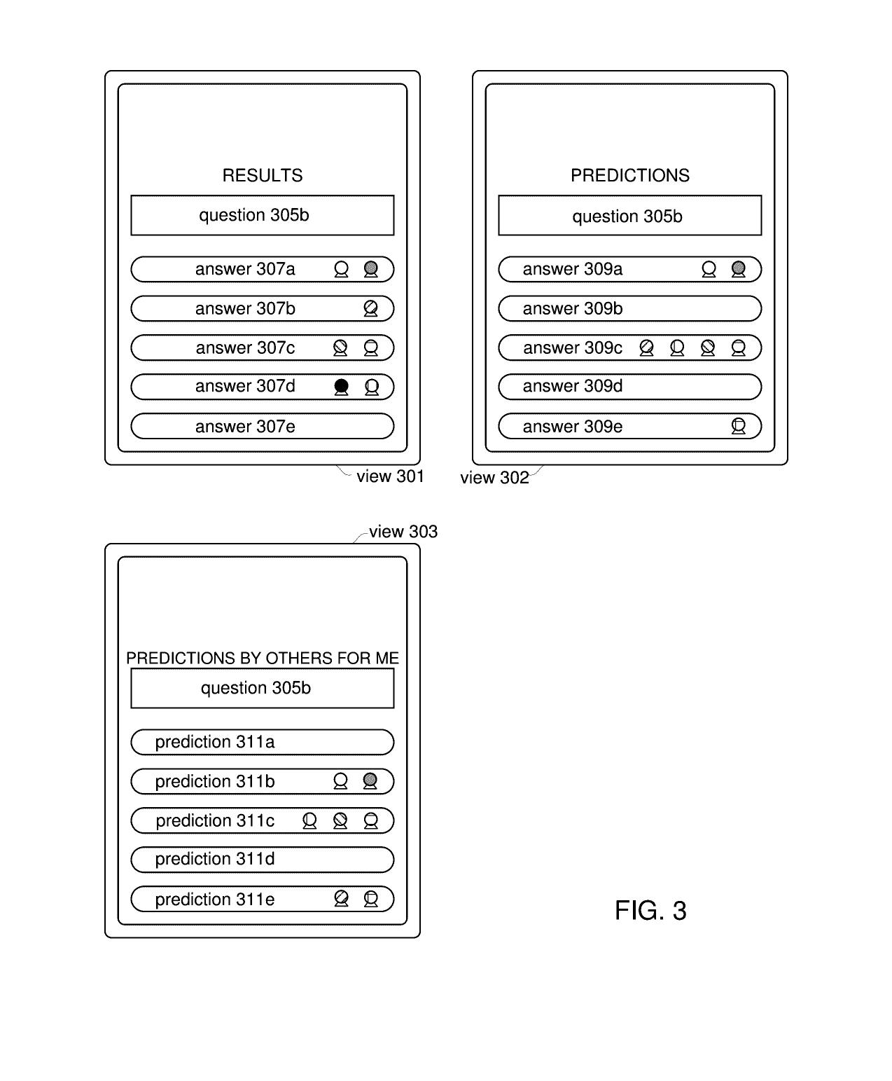

By way of non-limiting example, FIG. 3 illustrates three views of a graphical user interface as may be presented to a user: view 301, view 302, and view 303. View 301 depicts the results of a particular question 305b of a particular posting. View 301 may include names, icons, images, and/or other identifiable information that depicts which users from the social network selected which of the answers 307a-307e. For example, only one user selected answer 307b. In some embodiments, only users from a particular social network are shown. In some embodiments, users that are external to a particular social network can also be shown, for example based on whether there is room to add/show other users. In some embodiments, a view similar to view 301 may be combined with a view similar to view 203. By way of non-limiting example, view 1301 in FIG. 13 may include similar elements as view 301 in FIG. 3. In some embodiments, information about which users have answered a particular question may be included in the representation of view 201, which may entice a user to also answer that particular question.

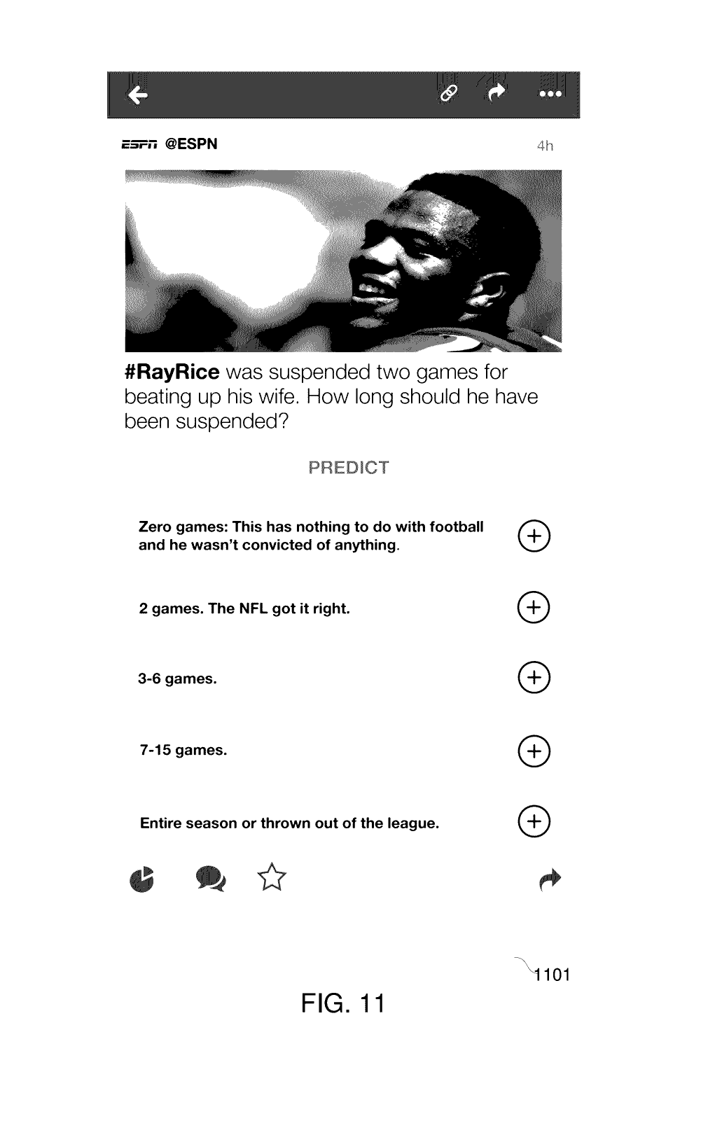

Prediction component 27 may be configured to receive user input that represents predictions for answers that have been, will be, and/or might be provided by users to particular questions. In some embodiments, prediction component 27 may be configured to receive a selection of one or more users and subsequently receive a selection of one or more answers to a particular question. In some embodiments, prediction component 27 may be configured to receive a selection of a particular answer to a particular question and subsequently receive a selection of one or more users. In some embodiments, prediction component 27 may be configured to receive predictions in any other manner that associated a particular user with a particular answer. For example, a user may provide user input that grabs and drags a representation of another user in his or her social network into an area of a user interface that represents a particular answer. A user may provide his or her prediction for the answers that have been, will be, and/or might be provided by other users in his or her social network and/or might be provided by celebrities, athletes, and/or influencers. By way of non-limiting example, view 1101 in FIG. 11 may include user interface elements that allow a particular user to provide predictions related to a specific question, by adding one or more users to the area or section shown for a specific answer. As illustrated in view 1101, the “+” symbol may be used to open a list of users for selection such that selecting a particular user causes the particular user to be added to the list of users that are predicted to answer the question in a manner corresponding to the answer next to the selected “+” symbol.

In some embodiments, the system may be configured such that a user can view which users have already answered a particular question, and subsequently provide predictions for other users that have not yet answered the particular question.

By way of non-limiting example, FIG. 3 illustrates view 302 depicting a set of predictions 309a-309e for a particular question 305b. For example, prediction 309e indicates that the user of view 302 has predicted that one particular user from the social network has answered or will answer 307e. For example, prediction 309c indicates that the user of view 302 has predicted that four particular users from the social network have answered or will answer 307c.

In some embodiments, prediction component 27 may be configured to receive predictions by a (sub)set of users for the answer a particular user has provided, will provide, and/or might provide. For example, ten users in the social network of a first user may predict the particular user's answer to a particular question. An aggregate of the predicted answers provided by the ten users may be “7 yes” and “3 no”. In some embodiments, the particular predicted answers and/or an aggregate thereof may be presented to the first user.

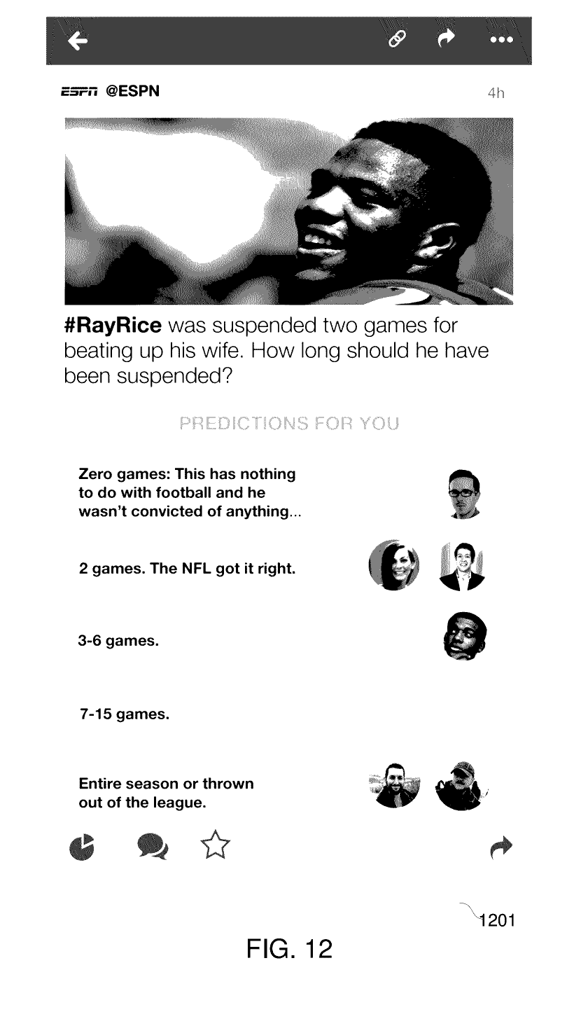

By way of non-limiting example, FIG. 3 illustrates view 303 depicting a set of predictions 311a-311e by other users (in the social network) for the particular user viewing view 303, regarding a particular question 305b. For example, prediction 311c indicates which three users have predicted the answer 307c for the particular user viewing view 303, regarding a particular question 305b. By way of non-limiting example, view 1201 in FIG. 12 may include similar elements as view 303 in FIG. 3.

In some embodiments, the system may be configured to provide users with summaries of how well they predicted. For example, “for Sports questions, you predict 58% correct.” The system may support head to head match ups between users. For example, user A predicts correctly for user B 89% of the time but user B predicts correctly for user A only 42% of the time. In some embodiments, the system may support that a user sees not only what his friend answered but what everyone predicted that friend would answer.

Notification component 28 may be configured to notify and/or effectuate notification of users. In some embodiments, a notification may pertain to an occurrence of a prediction as described in relation to prediction component 27. In some embodiments, notifications may be supported in the browser software application of a client computing platform. For example, notifications may be included in one or more presentations by computer program components, including but not limited to feed posting component 22, posting presentation component 25, and/or other components. For example, notifications may be presented in the GUIA or informational area. Alternatively, and/or simultaneously, in some embodiments, notifications may be supported through email messages. Alternatively, and/or simultaneously, in some embodiments, notifications may be supported through push notifications and/or in a notification location within a user-interface of the social networking platform.

For example, a first user may predict that a second user has provided or will provide a particular answer to a particular question. Notification component 28 may be configured to notify the second user that the first user has made (or more generally, that a certain number of users have made) a prediction pertaining to the second user. Once the second user has provided an answer, the first user may be notified whether he was right or wrong, what the actual answer was, how many people have provided answers, in particular similar answers, etc. For example, a notification may inform a user of how many users have provided answers and/or predictions pertaining to a particular question (e.g. a question posted by the particular user, a question answered by the particular user, a question for which the particular user has provided a prediction, a question for which other users have provided a prediction pertaining to the particular user, and/or other activities). In some embodiments, notifications may depend on whether some predetermined event and/or activity has occurred. For example, responsive to a particular user having answered a question, a notification about another user's prediction may include the predicted answer. In some embodiments, operations within the user interface may depend on whether some predetermined event and/or activity has occurred. For example, an acknowledgement by the particular user (e.g. through clicking or swiping a notification) of a prediction for the particular user may lead to different options for interaction based on whether the particular user has already provided an answer or not.

In some embodiments, notifications may include a status that may be modified by a user's actions within the system. For example, a status may include “read”, “unread”, and/or other statuses. Responsive to certain activities by the user, such a status may change.

In some embodiments, a notification may include a summary of pertinent activity within the social networking platform for a particular user. In some embodiments, a notification may include one or more postings, representations, and/or questions that, based on a determination by the system, the particular user might be interested in.

In some embodiments, notification component 28 may be configured to notify and/or effectuate notification of people who currently are not users of the social networking platform. Such notifications may be associated with an identifier of a user (e.g. a name, email address, phone number, and/or other identifier) and delivered through email, by text message, and/or through other delivery mechanisms. In some embodiments, once such a person has become a user of the social networking platform, the notifications previously associated with that person may be delivered.

Gamification component 29 may be configured to effectuate presentations to users that reflect prediction accuracy of the predictions of users. In some embodiments, gamification component 29 may be configured to present, to a particular user, subsequent to the particular user providing a set of predictions, information that reflects how accurate the predictions by the particular user have turned out to be. In some embodiments, an indication of accuracy level may be specific to a particular user in a set of users. For example, a first user may predict the answers provided by a second user to a set of questions with 80% accuracy, and by a third user to the same set of questions (and/or different questions) with 50% accuracy. For example, the second user may have predicted the first user's answers with 70% accuracy, whereas the third user may have predicted the first user's answers with 85% accuracy. In some embodiments, an indication of accuracy level may be specific to a set or subset of users. In some embodiments, an indication of accuracy level may include a one on one comparison between users. In some embodiments, an indication of accuracy level may be broken out by a myriad of different variables, including but not limited to variables chosen by the user, demographic information, and/or other information. In some embodiments, presentations reflecting prediction accuracy may include answers that a user has provided, for example for a wrong prediction. For example, a first user may predict that a second user will answer “A” for a particular question, but the second user provided answer “B”. The presentation and/or notification to the first user may reflect that the prediction for the second user was wrong and/or may reflect that the second user provided answer “B”.

Score component 30 may be configured to determine a quantification (which may be referred to as a “score” or a “VQ score”) for how many users have responded to one or more questions and/or provided predictions for the answers to one or more questions as prompted by (and/or potentially prompted by) the particular posting, answer, and/or predictions by a particular user. In other words, a particular posting, answer, and/or prediction by a particular user may cause activity in a social network, and that activity may in turn cause more activity. Score component 30 may be configured to quantify this activity. In some embodiments, one or more of such quantifications for a particular user may be referred to as a virality quotient (or “VQ”). For example, all or most activity by a user on the social network may correspond to a quantification. In some embodiments, a user's quantifications may be combined, e.g. by addition or some other mathematical calculation. In some embodiments, a user's quantifications may be static and/or cumulative, and/or otherwise monotonously increasing. In some embodiments, a user's quantifications may expire, decay, and/or otherwise reduce over time.

In some embodiments, the system may be configured to measures downstream activity. For example, predictions and answering may result in identical quantifications. In some embodiments, predictions and answering may be worth different amounts of quantifications. In some embodiments, the system may not count more than one interaction by a user to a question as the purpose is to inform users of how many people their interaction affected downstream. So if user 1 answers, which puts the question into user 3's feed and user 3 answers it, for the VQ score this may be counted as one point. If user 3 also predicts, the system may award another point. In some embodiments, if user 3 also predicts, the system may count user 3 as just one new user for user 1's VQ score. In some embodiments, VQ score may be determined question by question or topic by topic or subtopic by subtopic. In some embodiments, VQ score may be awarded to a particular user for a posting and/or question that the particular user did not post, but merely answered.

Virality component 31 may be configured to effectuate presentations to users that reflect quantifications (e.g. VQ scores) as determined by score component 30, and/or other components. For example, a particular user's virality quotient may be presented over time, and may, for example, reflect an increasing or decreasing level of influence (or at least effect in terms of causing activity) on the social network. In some embodiments, VQ scores may be used by the system to identify influential users (who may be referred to as influencers). VQ scores and/or the status as influencer may be used within the social networking platform (as well as external to it) for marketing, advertising, employment opportunities, etc.

In some embodiments, posting selection component 23 may be configured to select a subset of representations and/or postings for presentation to a user, e.g. based on stated user-specific preferences. In some embodiments, selection of representations and/or postings for presentation to a user may be based, at least in part, on the activity of a specific user in the social network. For example, selections of particular postings may convey an interest of the user. For example, a lack of selection of a particular posting may convey a lack of interest of the user for a particular topic and/or type of question. In some embodiments, selection of representations and/or postings for presentation to a user may be based, at least in part, on the predictions a user has made in the past. Alternatively, and/or simultaneously, in some embodiments, selection of representations and/or postings for presentation to a particular user may be based, at least in part, on the predictions other users have made in the past for the particular user.

For example, user one, user two and user three all follow each other. User one answers question #3. The system automatically includes question #3 in the pool of questions available to user 2 and user 3, even if that question would not have otherwise been in their pool. Because it is interesting to user one, it is probably interesting to user 2 and user 3. User 2 does not answer question #3 so nothing new happens in user 2's network. User 3 answers question #3. Now everyone who follows user 3 will now have question #3 in their pool of questions. However, a determination of where in the set of postings the particular posting with question #3 should appears may depend on many factors. For example, the system may attempt to determine the level of interest of a particular user in question #3. Through activity in the social networking platform, users and/or questions earn points. If two users regularly answer each other's questions, a new question answered by one user will be expected to be of interest to the other user. Questions with more points may appear higher and/or more prominently in the pool of questions.

It should be appreciated that although components 21-31 are illustrated in FIG. 1 as being located and/or co-located within a particular component of system 10, in embodiments in which physical processor 110 includes multiple processing units, one or more of components 21-31 may be located remotely from the other components. The description of the functionality provided by the different components 21-31 described herein is for illustrative purposes, and is not intended to be limiting, as any of components 21-31 may provide more or less functionality than is described. For example, one or more of components 21-31 may be eliminated, and some or all of its functionality may be incorporated, shared, integrated into, and/or otherwise provided by other ones of components 21-31. Note that physical processor 110 may be configured to execute one or more additional components that may perform some or all of the functionality attributed below to one of components 21-31.

Electronic storage 60 in FIG. 1 comprises electronic storage media that electronically stores information. The electronic storage media of electronic storage 60 may include one or both of system storage that is provided integrally (i.e., substantially non-removable) with system 10 and/or removable storage that is connectable to system 10 via, for example, a port (e.g., a USB port, a FIREWI RE port, etc.) or a drive (e.g., a disk drive, etc.). Electronic storage 60 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. Electronic storage 60 may store software algorithms, information determined by physical processor 110 or any computer program components, information received via a user interface, and/or other information that enables system 10 to function properly. For example, electronic storage 60 may store postings (as discussed elsewhere herein), and/or other information. Electronic storage 60 may be a separate component within system 10, or electronic storage 60 may be provided integrally with one or more other components of system 10 (e.g., physical processor 110).

User interface 76 of system 10 in FIG. 1 may be configured to provide an interface between system 10 and a user (e.g. a remote user using a graphical user interface) through which the user can provide information to and receive information from system 10. This enables data, results, and/or instructions and any other communicable items, collectively referred to as “information,” to be communicated between the user and system 10. An example of information that may be conveyed to a user is a flight parameter, a control parameter, an error condition, etc. Examples of interface devices suitable for inclusion in user interface 76 include a keypad, buttons, switches, a keyboard, knobs, levers, a display screen, a touch screen, speakers, a microphone, an indicator light, an audible alarm, and a printer. Information may be provided to a user by user interface 76 in the form of auditory signals, visual signals, tactile signals, and/or other sensory signals.

It is to be understood that other communication techniques, either hard-wired or wireless, are also contemplated herein as user interface 76. For example, in one embodiment, user interface 76 may be integrated with a removable storage interface provided by electronic storage 60. In this example, information is loaded into system 10 from removable storage (e.g., a smart card, a flash drive, a removable disk, etc.) that enables the user(s) to customize system 10. Other exemplary input devices and techniques adapted for use with system 10 as user interface 76 include, but are not limited to, an RS-232 port, RF link, an IR link, modem (telephone, cable, Ethernet, internet or other). In short, any technique for communicating information with system 10 is contemplated as user interface 76.

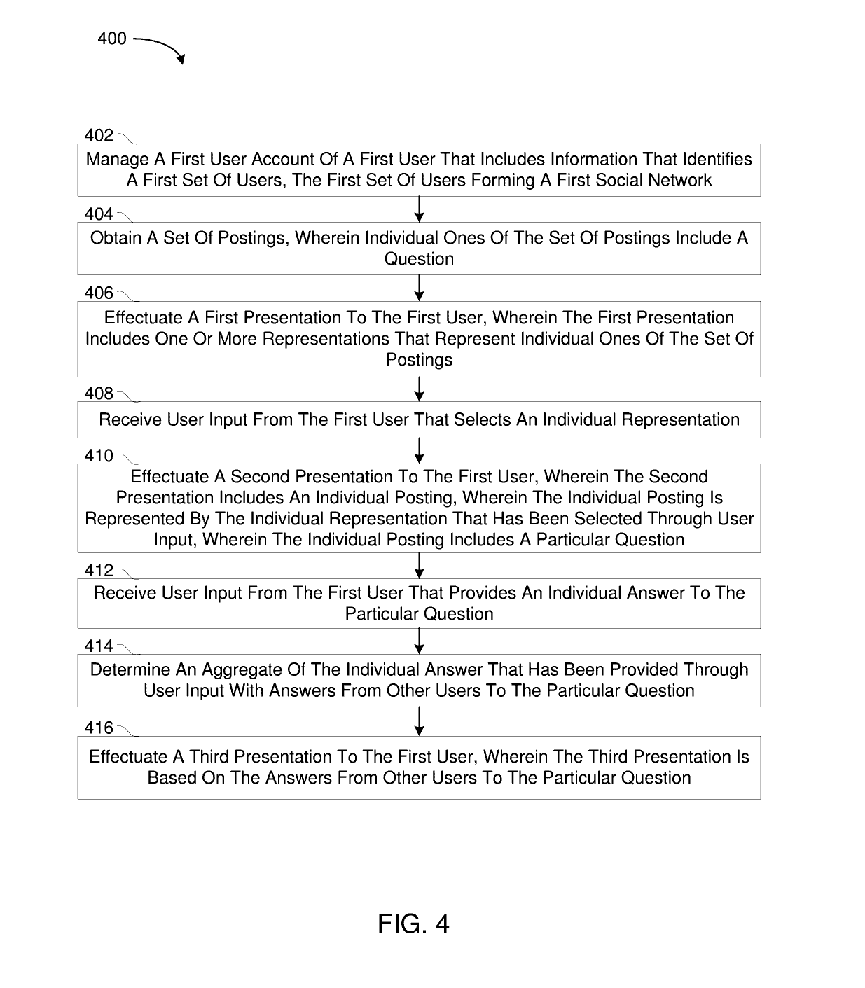

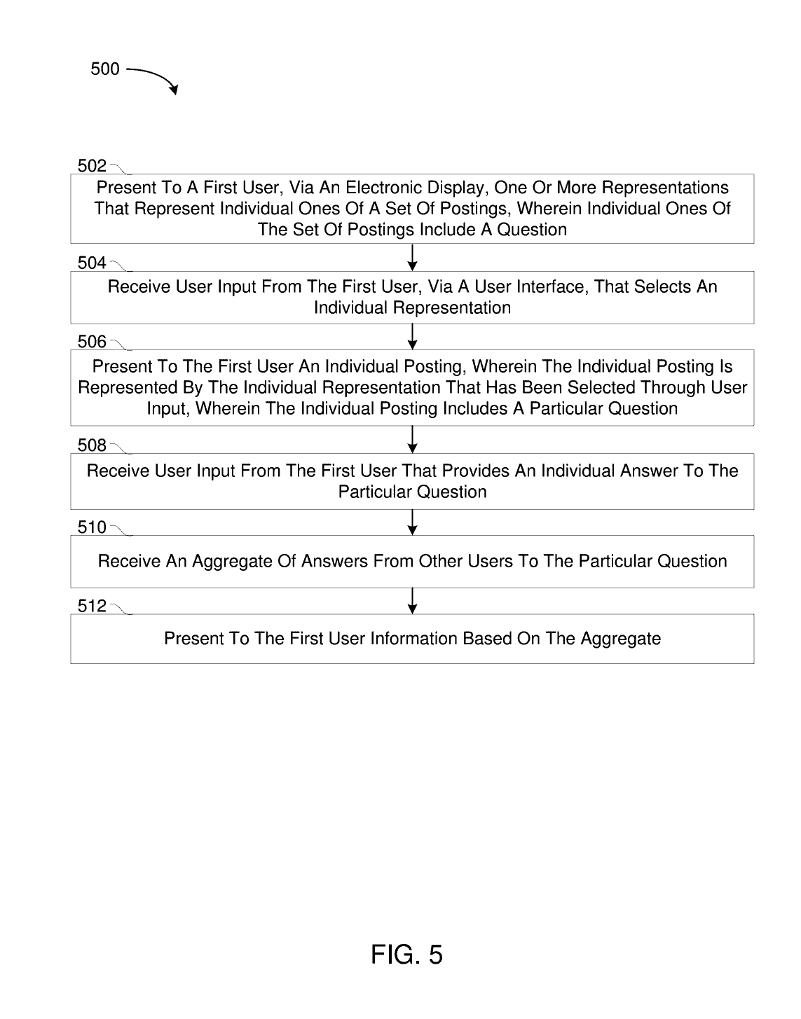

FIG. 4 illustrates an exemplary method 400 for hosting a social networking platform that enables users to interact with other users. FIG. 5 illustrates an exemplary method 500 for interacting within a social networking platform that enables a first user to interact with a set of users that forms the social network of the first user. The operations of methods 400-500 presented below are intended to be illustrative and non-limiting examples. In certain embodiments, methods 400-500 may be accomplished with one or more additional operations not described, and/or without one or more of the operations discussed. Additionally, the order in which the operations of methods 400-500 are illustrated in FIGS. 4 and 5 and described below is not intended to be limiting.

In certain embodiments, methods 400-500 may be implemented in one or more processing devices (e.g., a digital processor, an analog processor, a digital circuit designed to process information, an analog circuit designed to process information, and/or other mechanisms for electronically processing information). The one or more processing devices may include one or more devices executing some or all of the operations of methods 400-500 in response to instructions stored electronically on an electronic storage medium. The one or more processing devices may include one or more devices configured through hardware, firmware, and/or software to be specifically designed for execution of one or more of the operations of methods 400-500.

Regarding method 400, at an operation 402, a first user account is managed that is associated with a first user. The first user account includes information that identifies a first set of users. The first set of users forms a first social network of the first user. In some embodiments, operation 402 is performed by an account management component the same as or similar to account management component 21 (shown in FIG. 1 and described herein).

At an operation 404, a set of postings is obtained. Individual ones of the set of postings may include a question. In some embodiments, operation 404 is performed by a feed posting component the same as or similar to feed posting component 22 (shown in FIG. 1 and described herein).

At an operation 406, a first presentation to the first user is effectuated. The first presentation includes one or more representations that represent individual ones of the set of postings. In some embodiments, operation 406 is performed by a posting selection component the same as or similar to posting selection component 23 (shown in FIG. 1 and described herein).

At an operation 408, user input is received from the first user that selects an individual representation. In some embodiments, operation 408 is performed by a user interface component the same as or similar to user interface component 24 (shown in FIG. 1 and described herein).

At an operation 410, a second presentation to the first user is effectuated. The second presentation includes an individual posting. The individual posting is represented by the individual representation that has been selected through user input and/or through some other means. The individual posting may include a particular question. In some embodiments, operation 410 is performed by a posting presentation component the same as or similar to posting presentation component 25 (shown in FIG. 1 and described herein).

At an operation 412, user input from the first user is received that provides an individual answer to the particular question. In some embodiments, operation 412 is performed by a user interface component the same as or similar to user interface component 24 (shown in FIG. 1 and described herein).

At an operation 414, an aggregate is determined of the individual answer (the aggregate may or may not include the answer provided by this individual user) that has been provided through user input with answers from other users to the particular question. In some embodiments, operation 414 is performed by an aggregation component the same as or similar to aggregation component 26 (shown in FIG. 1 and described herein).

At an operation 416, a third presentation to the first user is effectuated. The third presentation is based on the answers from other users to the particular question. In some embodiments, operation 416 is performed by a posting presentation component the same as or similar to posting presentation component 25 (shown in FIG. 1 and described herein).

Regarding method 500, at an operation 502, one or more representations are presented to the first user that represent individual ones of the set of postings. Individual ones of the set of postings may include a question. In some embodiments, operation 502 is performed by a posting selection component the same as or similar to posting selection component 23 (shown in FIG. 1 and described herein).

At an operation 504, user input from the first user is received that selects an individual representation. In some embodiments, operation 504 is performed by a user interface component the same as or similar to user interface component 24 (shown in FIG. 1 and described herein).

At an operation 506, an individual posting is presented to the first user. The individual posting is represented by the individual representation that has been selected through user input. The individual posting includes a particular question. In some embodiments, operation 506 is performed by a posting presentation component the same as or similar to posting presentation component 25 (shown in FIG. 1 and described herein).

At an operation 508, user input is received from the first user that provides an individual answer to the particular question. In some embodiments, operation 508 is performed by a user interface component the same as or similar to user interface component 24 (shown in FIG. 1 and described herein).

At an operation 510, an aggregate is determined of answers from other users to the particular question. In some embodiments, operation 510 is performed by an aggregation component the same as or similar to aggregation component 26 (shown in FIG. 1 and described herein).

At an operation 512, information is presented to the first user that is based on the aggregate. In some embodiments, operation 512 is performed by a posting presentation component the same as or similar to posting presentation component 25 (shown in FIG. 1 and described herein).

Although the disclosed technology has been described in detail for the purpose of illustration based on what is currently considered to be the most practical and preferred embodiments, it is to be understood that such detail is solely for that purpose and that the disclosure is not limited to any particular embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

What is claimed is:

1. A system configured to host a social networking platform that enables users to interact with other users, the system comprising electronic storage and one or more physical processors configured via computer-readable instructions to:
manage a first user account associated with a first user, wherein the first user account includes information that identifies a first set of users, wherein the first set of users forms a first social network of the first user;
obtain a set of postings, wherein individual ones of the set of postings include a question;
effectuate a first presentation to the first user, wherein the first presentation includes one or more representations that represent individual ones of the set of postings;
receive user input from the first user that selects an individual representation;
effectuate a second presentation to the first user, wherein the second presentation includes an individual posting, wherein the individual posting is represented by the individual representation that has been selected through user input, wherein the individual posting includes a particular question;
receive user input from the first user that provides an individual answer to the particular question;
determine an aggregate of the individual answer that has been provided through user input with answers from other users to the particular question; and
effectuate a third presentation to the first user, wherein the third presentation is based on the answers from other users to the particular question.

2. The system of claim 1, wherein the individual posting further includes a particular set of selectable answers, and wherein one or more individual answers to the particular question are selected from the particular set of selectable answers.

3. The system of claim 2, wherein the third presentation reflects percentages of the other users that have selected a particular answer from the particular set of selectable answers.

4. The system of claim 1, wherein the third presentation is further based on the individual answer.

5. The system of claim 1, wherein the third presentation is further based on user-specific demographic information of the other users that have answered the particular question, wherein the user-specific demographic information includes one or more different variables, wherein the different variables include one or more of age, gender, race, economic status, geographic information, sexual preference, and political preference.

6. The system of claim 1, wherein the one or more physical processors are further configured to receive user input from the first user that provides a demographic selection of the other users that have answered the particular question, wherein the third presentation is further based on the demographic selection, wherein the demographic selection is associated with one or more different variables, and wherein the different variables include one or more of age, gender, race, economic status, geographic information, sexual preference, and political preference.

7. The system of claim 1, wherein the second presentation further includes a selectable link to an online article pertaining to the particular question.

8. The system of claim 2, wherein the one or more physical processors are further configured to:
receive user input from the first user that selects one or more individual users from the first set of users;
receive user input from the first user that effectuates one or more selections of one or more answers from the particular set of selectable answers, wherein the one or more selections represent one or more predictions for answers by the one or more individual users to the particular question;
notify the one or more individual users that user input has been received pertaining to the one or more individual users.

9. The system of claim 2, wherein the one or more physical processors are further configured to:
receive user input from one or more individual users from the first set of users that include one or more selections of one or more answers from the particular set of selectable answers, wherein the one or more selections represent one or more predictions by the one or more individual users for one or more answers of the first user to the particular question; and
effectuate a fourth presentation to the first user, wherein the fourth presentation indicates the one or more predictions by the one or more individual users for the one or more answers to the particular question.

10. The system of claim 1, wherein the first presentation further includes an indication of an individual user from the first set of users that indicates the individual user has answered the particular question.

11. The system of claim 1, wherein the one or more physical processors are further configured to:
receive particular user input from the first user that interacts with the first presentation, wherein the particular user input includes swiping up or down;
subsequent to receiving the particular user input, effectuate a presentation that includes an animation of an individual representation that represents an individual one of the set of postings being moved off-screen; and
subsequent to the animation, effectuate a presentation that includes a different representation than the individual representation.

12. The system of claim 4, wherein the one or more physical processors are further configured to:
receive user input from the first user that provides the individual answer, wherein the individual answer includes a public answer and a private answer; and
share information regarding the first user and the particular question with one or more of the first set of users, wherein the information being shared includes the public answer, wherein the information being shared does not include the private answer, wherein the percentages as reflected in the third presentation are based on the private answer, and wherein the percentages as reflected in the third presentation are not based on the public answer.

13. The system of claim 8, wherein the one or more physical processors are further configured to effectuate a fifth presentation to the first user, wherein the fifth presentation reflects an accuracy of the one or more predictions.

14. The system of claim 9, wherein the one or more physical processors are further configured to determine a selection of individual ones of the set of postings for presentation to the first user, wherein the selection is based on the one or more predictions by the one or more individual users.

15. The system of claim 1, wherein individual ones of the first set of users are associated with individual social networks of users, wherein the one or more physical processors are further configured to:
notify the first set of users that the first user has provided the individual answer to the particular question;
determine a quantification for how many of the users downstream from the first user have provided answers to the particular question;
effectuate a sixth presentation to the first user, wherein the sixth presentation reflects the quantification.

16. The system of claim 10, wherein the individual user has answered the particular question in a publicly available medium outside of the system.

17. A client computing platform configured to interact with a social network that enables a first user to interact with a set of users that forms the social network of the first user, the client computing platform comprising:
a user interface configured to provide user interaction to the first user;
an electronic display configured to present information to the first user; and
one or more physical processors configured via computer-readable instructions to:
present to the first user, via the electronic display, a representation that represent an individual one of a set of postings, wherein the individual one of the set of postings includes a particular question;
present to the first user an individual posting, wherein the individual posting is represented by the individual representation that has been selected through user input, wherein the individual posting includes a particular question;
receive user input from the first user that provides an individual answer to the particular question;
receive an aggregate that reflects answers from other users to the particular question; and
present information to the first user that is based on the aggregate.

18. A system configured to host a social network that enables users to interact with other users, the system comprising electronic storage and one or more physical processors configured via computer-readable instructions to:
manage a first user account associated with a first user, wherein the first user account includes information that identifies a first set of users, wherein the first set of users forms a first social network of the first user;
obtain a set of postings, wherein individual ones of the set of postings include a question;
effectuate a first presentation to the first user, wherein the first presentation includes an individual posting, wherein the individual posting includes a particular question;
receive user input from the first user that selects one or more individual users from the first set of users;
receive user input from the first user that provides one or more answers, wherein the one or more answers represent one or more predictions for answers by the one or more individual users to the particular question; and
notify the one or more individual users that user input has been received pertaining to the one or more individual users.

19. A client computing platform configured to interact with a social network that enables a first user to interact with a set of users that forms the social network of the first user, the client computing platform comprising:
a user interface configured to provide user interaction to the first user;
an electronic display configured to present information to the first user; and
one or more physical processors configured via computer-readable instructions to:
present to the first user, via the electronic display, a representation that represent an individual one of a set of postings, wherein the individual one of the set of postings include a particular question;
receive user input from the first user that selects one or more individual users from the first set of users;
receive user input from the first user that provides one or more answers, wherein the one or more answers represent one or more predictions for answers by the one or more individual users to the particular question; and
notify the one or more individual users that user input has been received pertaining to the one or more individual users.

20. A method for hosting a social network that enables users to interact with other users, the method being implemented in a computer system that includes electronic storage and one or more physical processors, the method comprising:
managing a first user account associated with a first user, wherein the first user account includes information that identifies a first set of users, wherein the first set of users forms a first social network of the first user;
obtaining a set of postings, wherein individual ones of the set of postings include a question;
effectuating a first presentation to the first user, wherein the first presentation includes an individual posting, wherein the individual posting includes a particular question;
receiving user input from the first user that provides an individual answer to the particular question;
determining an aggregate of the individual answer that has been provided through user input with answers from other users to the particular question; and
effectuating a second presentation to the first user, wherein the second presentation is based on the answers from other users to the particular question.

21. A method for interacting with a social network that enables a first user to interact with a set of users that forms the social network of the first user, the method being implemented in a computer system that includes electronic storage, a user interface, an electronic display, and one or more physical processors, the method comprising:
presenting to the first user, via the electronic display, one or more representations that represent individual ones of the set of postings, wherein individual ones of the set of postings include a question;
receiving user input from the first user, via the user interface, that selects an individual representation;
presenting to the first user an individual posting, wherein the individual posting is represented by the individual representation that has been selected through user input, wherein the individual posting includes a particular question;
receiving user input from the first user that provides an individual answer to the particular question;
receiving an aggregate that reflects answers from other users to the particular question; and
presenting to the first user information based on the aggregate.
